(19) United States
(12) Patent Application Publication
(10) Pub. No.: US 2019/0048301 A1
(43) Pub. Date: Feb. 14, 2019

(54) PROCESS FOR MATURING AT LEAST ONE ALCOHOLIC LIQUID WITH RECOVERY OF VOLATILE COMPOUNDS AND CORRESPONDING PLANT

(71) Applicants: Olivier Maroy, ANGOULEME (FR); Renaud Maroy, Paris (FR)

(72) Inventor: Olivier MAROY, ANGOULEME (FR)

(21) Appl. No.: 16/079,526

(22) PCT Filed: Feb. 23, 2017
(86) PCT No.: PCT/EP2017/054242

§ 371 Date: Aug. 23, 2018

(30) Foreign Application Priority Data
Feb. 24, 2016 (FR) 16 51513

(51) Int. Cl. C12H 1/22; C12H 1/14; C12G 3/07; B01D 53/00; B01D 53/22; B01D 53/04; B01D 53/047; C11B 9/00

(52) U.S. Cl. CPC C12H 1/22; C12H 1/14; C12G 3/065; B01D 53/002; B01D 2257/708; B01D 53/0462; B01D 53/047; B01D 53/0476; C11B 9/0015; B01D 53/22

(57) ABSTRACT

The invention relates to a process for maturing at least one alcoholic liquid (5) including the following steps:
using an airtight or semi-airtight chamber (15) located in a wine cellar, and containing at least one container (24) that contains an alcoholic liquid, the container being at least partly made from wood or containing wood, and an internal atmosphere (17) including oxygen,
maturing the alcoholic liquid in the container, the maturation releasing volatile compounds into the internal atmosphere,
extracting a portion of the internal atmosphere from the chamber in order to obtain a gaseous mixture (32) to be treated,
separating the gaseous mixture to be treated into at least a residual gaseous mixture (34) depleted in said volatile compounds, and at least one recovered liquid (36) containing at least some of the volatile compounds,
evacuating at least a portion of the residual gaseous mixture to the outside of the chamber, and
allowing air into the chamber by forced convection,
the recovered liquid being intended to form an alcoholic beverage or an ingredient of a composition, in particular an alcoholic beverage or a perfume.

The present invention relates to a process for maturing at least one alcoholic liquid in a container made at least partially from wood.

The invention also relates to an installation for maturing at least one alcoholic liquid.

The alcoholic liquids in question are wines, spirits, or wines mixed with spirits, which age in wooden barrels, casks, tuns or drums, most often made from oak, stored in a wine cellar. Wineries are locations, warehouses, buildings or rooms where wines or spirits are stored to be aged in casks, etc. Wineries are enclosed spaces that few people enter. They are equipped with few machines, aside from electric lift trucks for the most part. Modern wineries are kept at an optimal temperature and degree of hygrometry for aging of the wines and spirits. The air is kept saturated with alcohol in order to limit evaporation.

Exchanges take place for years, or even decades, between the alcoholic liquid and the container, and enrich the alcoholic liquid with more or less volatile compounds giving it its flavor. The oxygen present in the vapor phase of the container allows the alcoholic liquid to be oxidized irreversibly. The oxygen is renewed by an oxygen contribution coming from the wine cellar through the walls of the container.

The maturation of the alcoholic liquid releases, outside the container, volatile compounds coming from the alcoholic liquid or the vapor phase. These volatile compounds present in the atmosphere of the wine cellar ultimately escape, and are therefore called the “angels' share”.

These volatile compounds, or “angels' share”, allow the fungus Baudoinia compniacensis to appear on the walls outside the wine cellar. The proliferation of this fungus gives the walls a blackish color.

One aim of the invention is therefore to eliminate or reduce these inconveniences, i.e., in particular to provide a maturation process making it possible to prevent or limit the development of these fungi, the process having to be compatible with the traditional working of a wine cellar and the food standards in force, and if possible having a modest cost.

To that end, the invention relates to a process for maturing at least one alcoholic liquid, the alcoholic liquid being intended to become an alcoholic beverage or an alcoholic beverage ingredient, the process including at least the following steps:
using a chamber located in a wine cellar, and containing at least one container that contains the alcoholic liquid, the container being at least partly made from wood or containing wood, and an internal atmosphere including oxygen, the chamber being airtight or semi-airtight,
optionally making the chamber airtight,
maturing the alcoholic liquid in the container, the maturation consuming some of the oxygen present in the internal atmosphere and releasing volatile compounds coming from the alcoholic liquid into the internal atmosphere,
extracting a portion of the internal atmosphere from the chamber in order to obtain a gaseous mixture to be treated comprising at least a portion of the volatile compounds,
separating the gaseous mixture to be treated into at least a residual gaseous mixture depleted in said volatile compounds relative to the gaseous mixture to be treated, and at least one recovered liquid containing at least some of the volatile compounds of the gaseous mixture to be treated,
evacuating at least a portion, preferably all, of the residual gaseous mixture to the outside of the chamber, and
allowing air into the chamber by forced convection,
the recovered liquid being intended to form an alcoholic beverage or an ingredient of a composition, in particular an alcoholic beverage or a perfume.

According to specific embodiments, the process includes one or more of the following features, considered alone or according to any technically possible combination(s):
the chamber is formed by the wine cellar itself, a portion of the wine cellar, or a container located in the wine cellar;
the extraction is done by an extractor located outside the wine cellar, or the separation of the gaseous mixture to be treated is done outside the wine cellar, or evacuation is done outside the wine cellar;
the process further includes a step for storing the recovered liquid in at least one receptacle, preferably having at least one unidirectional inlet to receive the recovered liquid;
the process further includes a step for measuring the oxygen level or the level of one or several of the volatile compounds in the internal atmosphere of the chamber, and preferably a step for regulating one or several of these levels, the regulating step including a modification of the step for extracting a portion of the internal atmosphere of the chamber, or a modification of the air intake step;
the chamber contains several containers that respectively contain alcoholic liquids, the alcoholic liquids being identical according to one or several of the following criteria: varietal, soil, level of maturity and aging process;
the extraction of a portion of the internal atmosphere is done in a first location of the chamber, and the air intake is done in a second location of the chamber, the first location and the second location being opposite one another in the chamber so as to create gas sweeping around the container;
the separation is done at least by one or several of the following modules:
   a PSA, VSA or TSA separating module containing at least one adsorbent bed, the adsorbent being suitable for selectively adsorbing the air from the gaseous mixture to be treated relative to the at least one portion of the volatile components present in the gaseous mixture to be treated, or at least one portion of the volatile compounds relative to the air,
   a membrane separating module,
   a condenser suitable for condensing at least a portion of the volatile compounds present in the gaseous mixture to be treated, and
   a distiller suitable for distilling a mixture including at least a portion of the volatile compounds present in the gaseous mixture to be treated; and
the separation is split so as to obtain the recovered liquid and one or several other recovered liquids, each of the other recovered liquids including a portion of the volatile compounds present in the gaseous mixture to be treated.

The invention also relates to an installation for maturing at least one alcoholic liquid intended to become an alcoholic beverage or an alcoholic beverage ingredient, the installation including:
at least one chamber intended to be located in a wine cellar, the chamber being airtight or semi-airtight and including an internal atmosphere including oxygen, the chamber optionally being made airtight,
at least one container intended to be located in the chamber and to contain the alcoholic liquid, the container being at least partially made from wood or containing wood, and the container being suitable for allowing maturing of the alcoholic liquid, the maturation consuming some of the oxygen present in the internal atmosphere and releasing volatile compounds coming from the alcoholic liquid into the internal atmosphere,
at least one extractor for extracting a portion of the internal atmosphere from the chamber and obtaining a gaseous mixture to be treated comprising at least a portion of the volatile compounds,
at least one separator for separating the gaseous mixture to be treated into at least a residual gaseous mixture depleted in said volatile compounds, and at least one recovered liquid containing at least some of the volatile compounds of the gaseous mixture to be treated,
at least one evacuation system for evacuating at least 50 vol %, preferably all, of the residual gaseous mixture to the outside of the chamber, and
at least one air intake system for allowing air into the chamber by forced convection,
the recovered liquid being intended to form an alcoholic beverage or an ingredient of a composition, in particular an alcoholic beverage or a perfume.

The invention will be better understood upon reading the following description, provided solely as an example, and in reference to the appended drawings, in which:

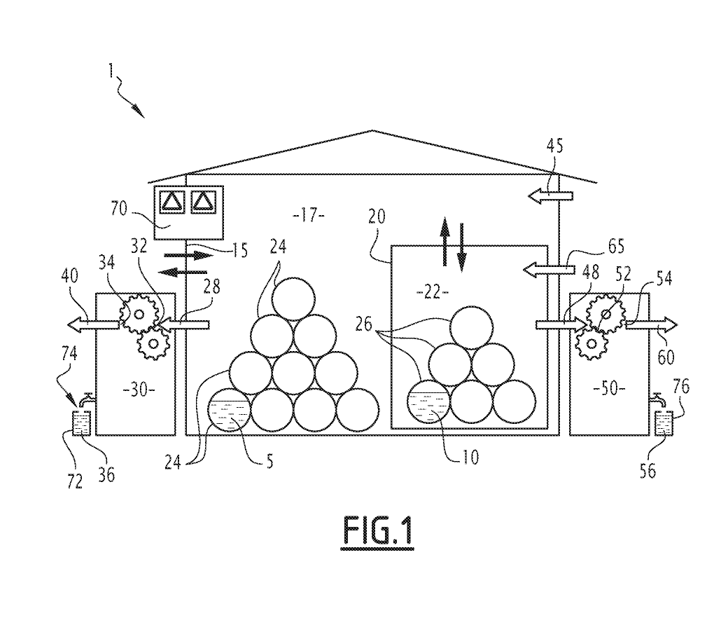

FIG. 1 is a schematic illustration of an installation according to the invention, and

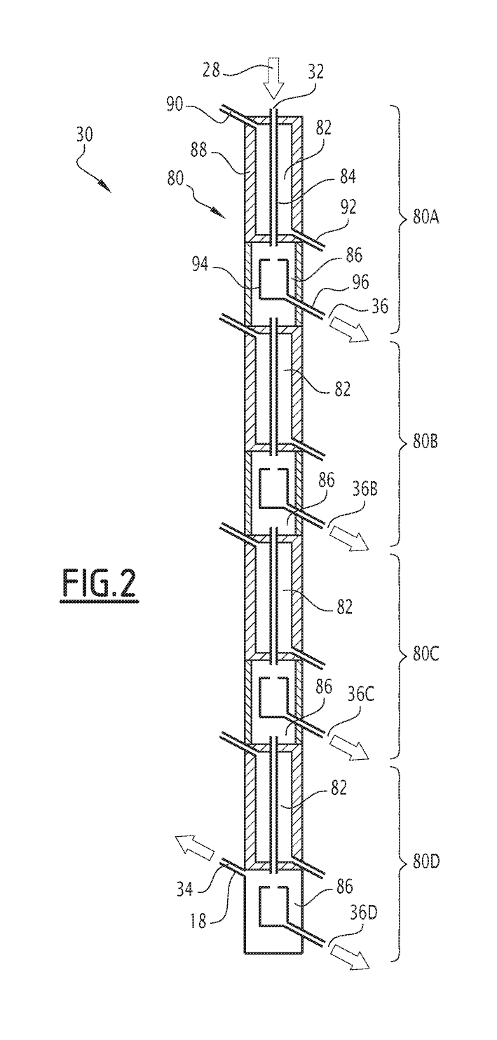

FIG. 2 is a schematic illustration of one of the separators shown in FIG. 1.

An installation 1 according to the invention is described in reference to FIG. 1. The installation 1 is intended for maturing, for example, two alcoholic liquids 5, 10 intended to become alcoholic beverages or alcoholic beverage ingredients. Alternatively (not shown), the installation 1 matures a larger number of alcoholic liquids.

The installation 1 is advantageously a wine cellar forming a first chamber 15 defining an internal atmosphere 17. The installation 1 for example includes a second chamber 20 located in the first chamber 15 and defining an inert atmosphere 22, a plurality of containers 24 located in the first chamber and containing the alcoholic liquid 5, and a plurality of containers 26 located in the second chamber and containing the alcoholic liquid 10.

The installation 1 comprises an extractor 28 for extracting a portion of the internal atmosphere 17 from the first chamber 15, and a separator 30 suitable for separating a gaseous mixture 32 extracted by the extractor into at least one residual gaseous mixture 34 and at least one recovered liquid 36. The installation 1 also comprises an evacuation system 40 suitable for evacuating at least one non-nil portion, preferably all, of the residual gaseous mixture 34 to the outside of the first chamber 15, i.e., into the atmosphere outside the wine cellar in the example, and an air intake system 45 into the first chamber 15.

In the illustrated example, the installation 1 also includes an extractor 48 suitable for extracting at least a portion of the internal atmosphere 22 from the second chamber 20, a separator 50 for separating a gaseous mixture 52 extracted by the extractor 48 into a residual gaseous mixture 54 and a recovered liquid 56, an evacuation system 60, and an air intake system 65 that are respectively similar to the extractor 28, the separator 30, the evacuation system 40 and the air intake system 45.

The alcoholic liquids 5 and 10 are wines or spirits, as mentioned above. The maturation of the alcoholic liquids 5, 10 consumes oxygen present in the internal atmospheres 17, 22 and releases volatile compounds coming from the alcoholic liquids into these internal atmospheres.

The volatile compounds contain many components, including water, alcohols and “aromatic” compounds (releasing a flavor), such as aldehydes, esters, and optionally one or several ketoacids. The volatile compounds, or “angels' share”, have a very recognizable scent. Their concentration in the internal atmospheres 17, 22 in particular depends on the average temperature in the first chamber 15 and the second chamber 20.

The recovered liquids 36, 56 are intended to form one or several alcoholic beverages or one or several ingredients of a composition, in particular an alcoholic beverage or a perfume.

The chambers within the meaning of the invention are either made up of the wine cellar itself, like the first chamber 15, or are an identifiable part of the wine cellar, or indeed are a container located in the wine cellar, like the second chamber 20.

According to alternatives that are not shown, the number of chambers is higher, and some are for example contained in other chambers, or advantageously in communication with one another.

The first chamber 15 advantageously includes one or several sensors 70 suitable for measuring the oxygen level, and/or the level of one or several volatile compounds, in particular alcohols, in the internal atmosphere 17. Advantageously, the sensors 70 are suitable for measuring one or several of the following parameters of the internal atmosphere 17: temperature, hygrometry, pressure.

The first chamber 15 and the second chamber 20 are airtight or semi-airtight. This means that these chambers restrict the exchanges of gas sufficiently between their internal atmospheres 17, 22 and their external environment, such that the volatile compounds escaping from the containers 24, 26 respectively accumulate in the internal atmospheres 17, 22. “Accumulate” means that the concentration of volatile compounds in the internal atmospheres 17, 22 is higher than that of the atmosphere surrounding the wine cellar, such that an operator (not shown), for example a cellar master, can smell the “angels' share” when he breathes in the internal atmospheres 17, 22.

A chamber is either a receptacle, or receptacles communicating with one another, or receptacles included in one another (partially or completely), or a location separated from the outside by walls and optionally having openings: a building, a wine cellar, a room of a building, a set of rooms, etc.

A chamber, like the first chamber 15, is for example pre-existing. In this case, it is preferably laid out. The wine cellar, for example, or a room in which the alcoholic liquids are decanted from young drums to old drums, in turn form an airtight chamber, in that they are delimited by walls, a floor and a ceiling that are semi-airtight, but comprise openings for people and optionally air to pass. Furthermore, the chamber may include openings or leaks related to the construction of the building. Said leaks and openings related to the construction of the building are preferably made airtight by means assumed to be known: spraying polymer films, polymer foam, etc. In order not to introduce toxic volatile products into the wine cellar, this sealing is for example done on the roof and in the exterior walls of the wine cellar.

Preferably, the access points for the passage of the equipment and the access points for pedestrian traffic are differentiated. Each access point preferably has a minimal size suited to the passage of staff and/or equipment, depending on the case. Each access point optionally allowing the passage of staff and equipment necessary for the operation of the wine cellar and the maturation of the alcoholic liquids is preferably equipped with mechanisms known in themselves for minimizing gaseous exchanges: airlocks, tambour door, sliding door, sectional door, slatted partition, traditional door, etc.

Each chamber preferably has its own extractor and its own separator. A same separator is optionally used for two separate chambers, but alternatively and separately if the alcoholic liquids differ between these chambers.

A chamber is intended to be opened as rarely as possible, and preferably has one or several of the following features:
it does not disrupt the aging mechanisms of the alcoholic liquid by guaranteeing identical or semi-identical aging parameters: composition of the internal atmosphere, ventilation, pressure, temperature, hygrometry, etc. and variation of these parameters over time. Nevertheless, the wine cellar is advantageously equipped with systems making it possible to monitor and adjust all or some of these parameters based on the cellar master's wishes. In particular, the alcohol level in the internal atmosphere is advantageously controlled;
it allows the visual inspection of the containers, for example by transparency over its entire surface or via carefully placed windows;
it makes it possible to view or measure whether a container is too empty and whether, as a result, an alcoholic liquid could be added to it;
it makes it possible to fill containers without having to open them;
it is preferably easy to open, the opening being large enough to manipulate, place and remove the container(s);
it comprises a stopper (not shown), for a simple exchange between the ambient air of the wine cellar and the air of the chamber in question;
it is suitable for displaying indicators or measuring devices for the properties directly or indirectly involved in the aging process for the alcoholic liquids (O2, H2O, alcohol, temperature, pressure, ventilation, etc.); and
it is equipped with systems for regulating the temperature, hygrometry, oxygen, ventilation, pressure.

Although the first chamber 15 and the second chamber 20 may not be completely airtight for the reasons explained above, they are advantageously made airtight by the processes described above.

The containers 24, 26 are at least partially made from wood or contain wood.

The containers allow the aging of an alcohol. Each container allows gaseous exchanges between the outside and the inside of the container, including the entry of oxygen into the container and the exit of the volatile compounds into the internal atmosphere of the chamber.

According to alternatives, all or part of the containers 24, 26 is made from metal, plastic, terra-cotta, ceramic, etc., with wood shavings or pieces inside, in contact with the alcoholic liquid.

The extractors 28 and 48 for example being similar to one another, only the extractors 28 will be described below.

The extractor 28 comprises an active or passive suction system (i.e., with or without a motor), preferably compatible with the food standards for alcohols. The extractor 28 is suitable for delivering the gaseous mixture 32 to be treated to the separator 30. The extractor 28 advantageously includes a peristaltic or membrane pump.

The extractor 28 is suitable for withdrawing a portion of the internal atmosphere 17 using any active or passive suction system known in themselves, preferably compatible with the food standards for alcohols, and sending the gaseous mixture 32 to be treated into the separator 30. The piping used in the extractor 28 is preferably compatible with food standards. The extractor 28 advantageously includes a filtration system (not shown), located before or after the inlet of the suction system.

Due to the variation of the content in volatile compounds as a function of temperature, and therefore with the seasons, the flow rate of the extractor 28 is preferably adjustable. This adjustment is preferably automatic and uses one or several parameters representative of the concentration in volatile compounds in the internal atmosphere 17.

The extractor 28 is preferably connected to the first chamber 15 in an airtight manner.

Alternatively, the connector is not airtight. For example, the gaseous mixture 32 to be treated is in contact with the outside of the first chamber 15 before being allowed into the extractor 28.

According to one particular embodiment, the extractor 28 is connected to several chambers preferably containing volatile compounds coming from containers containing an aged spirit, of similar origin, varietal and aging process (age of the containers, for example).

The extractor 28 is advantageously suitable for monitoring the flow rate and alcohol level contained in the gaseous mixture 32, and, with the air intake system 45, regulating the alcohol level contained in the internal atmosphere 17. The extractor 28 is preferably equipped with a filtration system (dust, particles, pollution, bacteria), not shown.

The separators 30, 50 are for example similar to one another, thus only the separator 30 will be described below.

The separator 30 is suitable for receiving the gaseous mixture 32 to be treated and separating it into the residual gaseous mixture 34 depleted in volatile compounds relative to the gaseous mixture to be treated, and at least the recovered liquid 36 containing at least some of the volatile compounds of the gaseous mixture to be treated.

The depletion in alcohols and in volatile compounds is either total, to completely avoid the appearance of fungus, or partial. In the latter case, in order to prepare an alcoholic beverage, more than half of the alcohol and volatile organic compounds is recovered in liquid form. With the aim of extracting only volatile aromatic compounds, the alcohol level in the residual gaseous mixture 34 is optionally high, whereas preferably, the alcohol is recovered in liquid form in largest part for other types of leveraging (e.g., bioethanol).

The recovered liquid 36 is for example stored in a receptacle 72, advantageously having a one-way inlet 74 in order to receive the liquid to be stored. Likewise, the separator 50 is suitable for producing a recovered liquid 56, for example stored in a receptacle 76 similar to the receptacle 72.

The separator 30 is for example located outside the largest chamber (here the first chamber 15).

Alternatively (not shown), the separator 30 is placed in the first chamber 15 or even in the second chamber 20.

Preferably, each separator is associated with a chamber. According to specific embodiments, several separators are used for a single chamber, or conversely, several chambers with a single separator.

Preferably, the separator 30, in particular its elements in contact with the gases, liquids and solids coming from the first chamber 15, comply with the food standards relative to the alcoholic beverages.

The separator 30 for example includes one or more of the following modules (not shown):
at least one PSA (pressure swing adsorption), VSA (vacuum swing adsorption) or TSA (temperature swing adsorption) separating module containing at least one adsorbent bed, the adsorbent being suitable for selectively adsorbing the air from the gaseous mixture 32 to be treated relative to at least one portion of the volatile compounds present in the gaseous mixture to be treated, or at least one portion of the volatile compounds relative to the air,
at least one membrane separating module,
at least one condenser 80 suitable for condensing at least a portion of the volatile compounds present in the gaseous mixture 32 to be treated, and
at least one distiller suitable for distilling a mixture including at least a portion of the volatile compounds present in the gaseous mixture 32 to be treated.

Advantageously the separator 30 is suitable for performing a split separation, as shown in FIG. 2, so as to obtain the recovered liquid 36 and several other recovered liquids 36B, 36B, 36D respectively including a portion of the volatile compounds present in the gaseous mixture 32 to be treated.

In reference to FIG. 2, we will now describe an example separator 30 suitable for performing a separation by stepped condensation.

In this example, the condenser 80 comprises four recovery modules 80A, 80B, 80C, 80D that are superimposed and similar to one another.

Each of the recovery modules 80A to 80D is suitable for performing a condensation of the gaseous mixture 32 to be treated respectively at given temperatures T_{A}, T_{B}, T_{C} and T_{D}, by decreasing temperature order.

Each of the recovery modules 80A to 80D includes a first portion 82 suitable for performing a condensation in a pipe 84 advantageously provided with balls, for example made from stainless steel, and a second portion 86 suitable for recovering a condensed phase respectively forming the recovered liquids 36, 36B, 36C, 36D.

The first portion 82 includes an insulating chamber 88, for example a Dewar flask, or a polyurethane foam insulation, an inlet 90, and an outlet 92 for a fluid or a solid suitable for cooling the gaseous mixture 32 to be treated.

The second portion 86 for example includes a receptacle 94 suitable for receiving condensed liquid droplets in the pipe 84 of the first portion 82, and an outlet 96 connected to the receptacle 94 and suitable for respectively evacuating the recovered liquids 36, 36B, 36C, 36D.

The structural elements of the column 80, aside from the insulation 88, are preferably made from materials in accordance with the food standards for the spirit in force in the country where the installation is located, highly thermally conductive for the pipe 84 and conducting very little heat for the elements making up the insulating chamber 88. Copper is preferably used for the pipe 84 if it is tolerated by the food standards in force for the spirit in the country where the installation is located, otherwise stainless steel is preferably used. The insulating chamber is preferably made from materials conducting little heat (e.g., polyurethane foam) or of the Dewar flask type.

The pipe 84 of the first module 80A is fluidly connected to the extractor 28 to receive the gaseous mixture 32 to be treated.

The second portion 86 of the last module 80D comprises an outlet 98 suitable for recovering the residual gaseous mixture 34 after it successively passes in the first portions 82 of the recovery modules 80A to 80D.

According to an alternative that is not shown, the recovery modules 80A to 80D includes several pipes 84 and/or several receptacles 94.

The separator 30 also includes supply systems (not shown), for renewing and purging cooling fluid or solid.

Although using several recovery modules makes it possible to limit the icing phenomenon, the column 80 is advantageously equipped with deicing systems.

The cooling fluid or solid is for example dry ice.

The recovered liquids 36B, 36C, 36D are intended to form one or several alcoholic beverages or one or several ingredients of a composition, in particular an alcoholic beverage or a perfume.

Other embodiments of the separator 30 (not shown) are described hereinafter.

### By Selective Adsorption of the Air Contained in the Gaseous Mixture to be Treated.

The selector according to the invention uses a known adsorption process (PSA, VSA, TSA, etc.) to specifically adsorb molecules from the atmospheric air (N2, O2, CO2, Ar, Ne, Xe, He, etc.), and/or water, and/or molecules from pollution (CO, NO, NO2, SO, SO2, fine particles, etc.), and preferably comprises at least one adsorbent, the diameter of the orifices of which is smaller than the molecular diameter of the smallest volatile compound (for example, ethanol). The adsorption processes for nitrogen or oxygen are known and used industrially. For example, 3 Å zeolites can be used.

The partial pressure of each volatile compound increases as the molecules from the atmospheric air are adsorbed. When this partial pressure exceeds the saturation vapor pressure of a compound, it condenses.

This condensation occurs in large part on the zeolites themselves during the adsorption. The difficulty of this solution lies in recovering the liquefied angels' share, which will tend to accumulate on the zeolites.

In the process according to the invention, the recovery of the condensed angels' share can be done in many ways: by agitation of the zeolites, by centrifugation, etc.

### By Selective Adsorption of All or Some of the Volatile Compounds of the Gaseous Mixture to be Treated.

The air and the volatile compounds are for example separated due to their different adsorption kinetics (critical temperatures and boiling temperatures).

The adsorption is even greater when the critical temperature and the boiling temperature of a molecule or a compound is high. Yet the critical temperatures of nitrogen (−147.1° C.) and oxygen (−118.67° C.) are much lower than those of water (374.15° C.) and volatile compounds derived from alcoholic liquids 5, 10 (e.g., ethanol (240.85° C.), aldehyde (192.85° C.), ethyl acetate (250.15° C.)). The property of the adsorbents is used according to which an adsorbent gas preferably displaces the other gases that had been adsorbent previously to separate the volatile compounds based on critical temperature and boiling criteria. The air is thus adsorbed, like the angels' share, but desorbs as the volatile compounds adsorb.

Under pressure and temperature conditions for example allowing the adsorption of the volatile compounds, but not that of the molecules from the atmospheric air, the volatile compounds and water are adsorbed during one or several adsorption phases and are recovered during one or several desorption phases. Due to the energy cost of water desorption, the water is preferably removed from the gaseous mixture 32 beforehand using another process, such as refrigeration, or a passage over alumina.

In order to desorb the volatile compounds, the separator according to the invention uses any known adsorption and desorption process (PSA, VSA, TSA, etc.).

The gaseous mixture 32 passes through one or several adsorbent beds. The adsorption process is followed by a regeneration of the adsorbent by desorption before a new saturation of the adsorbent in volatile compounds. The recovered liquid 36 is obtained during the desorption phase.

Adsorbents with different cavity opening diameters corresponding to the molecular diameters of the targeted volatile compounds may potentially be used. The respective proportions in adsorbents of each type are advantageously chosen such that the composition of the recovered liquid 36 corresponds to predetermined criteria, for example by the cellar master.

The adsorption is for example split into a series of recovery modules by adsorption. These modules operate using known processes, optionally different from one another (PSA, TSA, VSA, etc.).

For example, a first module comprising an adsorbent with a cavity diameter of 3 Å recovers water present in the gaseous mixture 32, and a second module comprising an adsorbent with a cavity diameter of 4 Å recovers primarily ethanol and aldehyde. A third module, with a cavity diameter of 5 Å or 6 Å, for example recovers acetic acid, a fourth module, with adsorbents with a cavity diameter of 6 Å or 7 Å, for example recovers ethyl acetate, 1-propanol, 1-butanol, ethyl benzoate, etc. A fifth module, with adsorbents having a cavity diameter greater than 6 Å, in particular recovers esters having a larger diameter.

### Membrane Separators

The volatile compounds are for example separated from the molecules of air, which are smaller, using one or several membranes. Advantageously, different groups of volatile compounds with different diameters are obtained. The water, which is small that some air molecules, remains mixed with the air.

The separation is advantageously split, owing to different processes (pervaporation, reverse osmosis, nanofiltration, ultrafiltration, etc.) and/or transfer motive power (pressure, temperature difference, centrifugal force, etc.) depending on the size of the molecules to be separated.

### Condensation

A decrease in the temperature results in decreasing the saturation vapor pressure.

When the saturation vapor pressure of a gas becomes lower than its partial pressure, the gas condenses. Furthermore, the less concentrated a compound or a molecule is in a gas, here the angels' share, the lower its partial pressure is. In order to obtain a condensation of these compounds, the temperature of the gaseous mixture to be treated is significantly decreased.

The separator for example uses any condensation process to recover the volatile compounds, either generally, or in a split manner by gradually decreasing the temperature and separately recovering the condensates at the different temperatures.

### General Condensation

The “angels' share” is generally made up of many molecules with very different melting temperatures, typically comprised between −127° C. and 23° C. The condensation of some volatile compounds is accompanied by freezing of other volatile compounds, the melting temperature of which is higher.

The condensation of the volatile compounds is obtained:
either by a decrease in the temperature using a known process: vapor-compression refrigeration (reverse Rankine cycle), gas absorption refrigeration (Carré cycle), turbo refrigeration (Joule cycle), Stirling motor, thermo-acoustic cooling, magnetic refrigeration, Ranque-Hilsch tube, Peltier module, etc.,
or by placement in direct or indirect contact with a gas, a liquid or a solid previously cooled (liquid nitrogen, dry ice, ice, etc.).

### Split Condensation

This is for example done in a plate tower.

The minimum temperature, at the head of the column, is suitable for the exiting gas to contain no or few volatile compounds, and for neither the oxygen nor the nitrogen of the gaseous mixture 32 to be treated to have been liquefied. The minimum temperature is also suitable for the volatile compound having the lowest melting temperature not to be frozen while having a saturation vapor pressure close to zero.

The volatile compounds corresponding to the different plates are recovered separately.

Preferably, in order to better separate the volatile compounds, the system can operate in 3 steps:
1) initialization phase: entry of the gas and liquefaction of a sufficient volume of volatile compounds,
2) closed operation until equilibrium of the various volatile compounds on their respective plates,
3) emptying of the overflow of the various plates.

Such a system it makes it possible to limit ice, but is not completely free thereof.

Before any deicing action, each plate is emptied by a drain, and the liquefied volatile compounds are recovered by a purge system. To perform the deicing, the minimum temperature is for example increased and the melted ice is recovered through the purge system.

Preferably, the temperature at each plate is adapted to the melting and boiling temperatures of the volatile compounds that one wishes to separate.

Optionally, each plate is equipped with its own temperature regulating system, in order to adjust the temperature of each plate to the melting temperature of the desired gas. Preferably, the number of plates is equal to the number of theoretical plates.

In practice, the volatile compounds are recovered by families based on their melting temperature. Indeed, some components have close melting temperatures, and it is difficult to separate them in this way.

Advantageously, the separator 30 combines several separating systems.

Below, several non-exhaustive combinations of processes for recovering and/or splitting volatile compounds are described in detail.
A. First process: Adsorption of the air or the angels' share and single splitting step

This process comprises two phases:

1) First phase: recovery of volatile compounds:
a. by general condensation, or
b. by adsorption of the air, or
c. by adsorption of the volatile compounds.

2) Second phase: splitting of the condensed volatile compounds:
a. Either by split distillation (any known process) optionally in two steps.
   i. A first step seeking splitting at a high flow rate, preferably using a plate tower,
   ii. A second step seeking high-precision separation, preferably using
a rotating band column.
b. Or by split adsorption of the volatile compounds, optionally followed by a fine split distillation (for example: rotating band column) separately on each obtained adsorbate fraction or on a selection of them
B. Second process: Split distillation after separation of the angels' share of the atmospheric air followed by a split adsorption.
C. Third process: Split condensation followed by:

1) Either a split distillation separately on each obtained condensate,

2) Or a split adsorption on each obtained condensate.
D. Fourth process: split adsorption followed by a split distillation separately on each obtained adsorbate fraction.
E. Fifth process: splitting of the volatile compounds in three steps

One begins with a split condensation followed by:

1) either a split distillation separately on each obtained condensate, then split adsorption on each obtained distillate,

2) or a split adsorption on each obtained condensate, then split distillation separately on each obtained adsorbate fraction.

The evacuation system 40 is suitable for recovering the residual gaseous mixture 34 and evacuating at least a portion of it, preferably all of it, to the outside of the first chamber 15.

The residual gaseous mixture 34 being depleted in alcohol and volatile compounds coming from the alcoholic liquids 5, 10, the risk of fungus appearing on or near the installation 1 is reduced.

Preferably, the residual gaseous mixture is completely discharged outside the outermost chamber. Indeed, the aging process of the alcoholic liquids and the presence of humans leading to oxygen consumption, it is preferable either to renew the internal atmosphere of the chambers with outside air with an atmospheric oxygen content, or to introduce oxygen artificially (oxygen tank, oxygen cartridge, etc.), on pain of disrupting and slowing the maturation of the spirits and endangering the staff working in the chamber 15.

The evacuation system 40 preferably checks the flow rate and alcohol level contained in the residual gaseous mixture 34 in order to verify that the latter no longer contains alcohol, or that the alcohol level is low enough.

The air intake system 45 is suitable for renewing the air of the internal atmosphere 17 by forced convection. Thus, the air intake system 45 for example includes a fan or a pump (not shown).

According to one particular embodiment, the air intake system 45 is only formed by one or several air inlets in the chamber 15, the forced convection being provided by the suction created by the extractor 28 and/or the evacuation system 40. The intake system 45 preferably includes filtration mechanisms, which are preferably successive, preventing animals (for example, a grate), dust, pollen (for example, fine filter), fine particles (for example, self-cleaning particle filter) and molecules from pollution (for example, adsorbent or honeycomb beds) from penetrating the chamber.

According to another particular embodiment, the extractor 28 and the air intake system 45 are respectively located in a first location and a second location of the first chamber 15, the first location and the second location being opposite one another in the first chamber so as to create gaseous sweeping around the containers 24.

The extractor 28, the separator 30 and the air intake system 45 are advantageously located outside or on the border of the wine cellar, i.e., of the first chamber 15 in the example shown in FIG. 1.

The operation of the installation 1 will now be described and illustrates a process according to the invention.

The containers 24 are first filled with alcoholic liquid 5 and stored in the first chamber 15. Advantageously, the containers 24 contain alcoholic liquids that are similar according to one or several of the following criteria: varietal, soil, level of maturity and aging process. Thus, the volatile compounds that they exhale are also similar.

The same is done with the alcoholic liquid 10 in the containers 26 stored in the second chamber 20.

The maturation of the alcoholic liquids 5, 10 releases the volatile compounds into the internal atmospheres 17, 22.

The operation of the first chamber 15 and the second chamber 20 being similar, only the operation of the first chamber 15 will be described below.

The extractor 28 extracts, from the first chamber 15, a portion of the internal atmosphere 17 in order to obtain the gaseous mixture 32 to be treated. The gaseous mixture 32 comprises a portion of the volatile compounds initially present in the internal atmosphere 17.

The separator 30 separates the gaseous mixture 32 into the residual gaseous mixture 34 depleted in the volatile compound and the recovered liquids 36, 36B, 36C, 36D.

The evacuation system 40 is suitable for recovering the residual gaseous mixture 34 and evacuating at least a portion of it, preferably all of it, to the outside of the first chamber 15.

The air intake system 45 allows fresh air into the first chamber 15 by forced convection. This renews the internal atmosphere 17 and in particular makes it possible to keep an oxygen level compatible with a human presence.

Advantageously, the flow rates of the extractor 28 and the air intake system 45 are regulated based on measurements done by the sensor(s) 70.

The safety of the installation 1 is advantageously increased.

Preferably, all of the equipment of the installation 1 complies with any present or future standard relative to the production of spirits in the country where the installation is located, for example with the food standards and the standards in force for explosive atmospheres (ATEX standards) requiring that no sparks be produced during the operation of the equipment. Due to the storage of flammable and explosive spirits, the wine cellar must comply with the laws related to at-risk sites (SEVESO zones in Europe).

The invention makes it possible to keep the alcohol level in the internal atmospheres 17, 22 below the flammability threshold. To that end, systems for measuring the alcohol vapor level (e.g., breath analyzers), such as the sensors 70, are preferably placed in each chamber, and the flow rate of the extractors 28 and 48 and the intakes 45 and 65 is preferably regulated so as to keep the alcohol and O₂ levels within the limits guaranteeing the safety of the site and people working on the site.

Thus, owing to the features described above, the maturation process prevents or limits fungus development and greatly limits the risks of explosion of the site, asphyxiation of staff, and occupational illness related to the inhalation of concentrated alcohol vapors. The process is further compatible with the traditional working of a wine cellar and the food standards in force, and has a modest cost.

The process and the installation according to the invention further have the interest of allowing the recovery and leveraging of all or part of the “angels' share”, which is lost in the maturation techniques of the prior art.

For example, the cognac and armagnac yields are low (1000 liters of spirit per hectare after distillation and 740 liters after 15 years). Recovering the “angels' share” makes it possible to increase the yield, especially for the oldest spirits, which are the most expensive.

This does not involve preventing the evaporation of the “angels' share”, which is necessary to concentrate the relatively non-volatile aromatic compounds in the containers 24, 26, but rather recovering it, and optionally checking its quantity by determining both the temperature in the wine cellar and the concentration of the angels' share in the atmosphere of the wine cellar. The process according to the invention therefore does not require changing the maturation process inside the containers 24, 26. The cellar master chooses the percentage of his inventory that will become the “angels' share” actually lost, and may choose to minimize this percentage by reintroducing the recovered liquid 56 into the containers 24, 26 from which the angels' share making it up comes.

Currently, wine cellars are kept as much as possible at alcohol saturation, which presents explosion risks, but makes it possible to limit the angels' share. The operation for reintroducing the recovered liquid 36 into the containers 24 is even more interesting when the level of alcohol and volatile compounds in the atmosphere of the chamber 17 is kept below the explosivity threshold. Indeed, in this case, the evaporation of the spirit will be greater, due to the difference, which is significant in summertime, in concentration of the alcohol and volatile aromatic compounds between the vapor phase above the spirit 5 and the atmosphere 17 of the chamber 15. This drawback, which the process according to the invention can overcome, is accompanied by an advantage: better O₂ ventilation.

Increasing the quantity of recovered liquid 36 in the container 24 dilutes the concentration in relatively non-volatile aromatic compounds characteristic of old spirits, but makes it possible to limit in fine the losses of spirits by evaporation. The cellar master may therefore determine a quantity of recovered liquid 36 reintroduced into the container 24 that he feels provides an optimal compromise between the gradual concentration of the relatively non-volatile aromatic compounds in said containers, on the one hand, this concentration being a characteristic of mature spirits, and the limitation of losses via the angels' share, on the other hand.

The cellar master may also decide to set the compromise differently for different degrees of maturation of the spirit (e.g., cognac).

These elements open the field for new aging techniques for alcoholic liquids, in particular cognac.

For example, the recovered liquid 36 is introduced into the alcoholic liquid 5 during the assembly stage in order to enrich it with volatile “aromatic” compounds.

The oxidation phenomenon of the alcoholic liquid, necessary for aging, is even more significant when the number of molecules of oxygen and alcoholic liquid in contact is high. By using the process according to the invention, the number of molecules of alcoholic liquid and of oxygen remains unchanged.

Oxidation of the volatile compounds present in the atmosphere also occurs, while the contact with the O2 is increased considerably. The recovered “angels' share” thus benefits from a “greater” maturation than that of the alcoholic liquid from which it is derived.

It is possible to consider introducing the recovered liquid:
either into the containers 24, 26 from which it evaporated,
or into containers (not shown) specifically dedicated to the “angels' share”, for aging no longer of “X” (X for example being cognac, armagnac, rum, Scotch, Irish whiskey, bourbon, etc.), but of the “angels' share of X”,
or into containers (not shown) for aging an assembly of “X” and the “angels' share of X”.

The invention makes it possible to preserve cognac for a very long period. It is possible to reduce the loss of alcoholic liquid considerably by:
reintroducing the recovered “angels' share” into the containers that it comes from.
compensating for the oxygen consumption by introducing oxygen alone into the container. This oxygen can be provided by an oxygen cartridge, by compressed oxygen, by liquid oxygen or by an oxygen generator located in or close to the wine cellar.

The invention makes it possible to better monitor the atmosphere around alcoholic liquid containers. During the maturation of the alcoholic liquids, the dominant processes (“digestion” of the wood, oxidation, etc.) change, such that the needs change as well. With the process according to the invention, it becomes possible to adjust the environment of the containers so as to optimize the maturation. Indeed, it is possible to adjust the temperature, pressure, ventilation, oxygen content and angels' share content finely. In particular, it is possible to keep the level of volatile compounds as close as possible to the saturation value in the chambers where people intervene very little or not at all, so as to allow the oxidation of the alcoholic liquid while limiting its evaporation.

The safety of the wine cellars is improved. This element is preferably taken into account by the process according to the invention, since replacing ventilation by opening doors and windows with forced convection makes it possible to guarantee that the levels of oxygen and some of the volatile compounds remain compatible with a potential human presence and with control of ignition risks.

The invention allows a rapid, although natural, aging process consisting less—potentially much less—of filling the containers with alcoholic liquid than is done traditionally, in particular in the aging phases during which oxidation is crucial. In this way, the oxidation of the alcoholic liquid is more significant than traditionally, at the cost of greater evaporation. This last point is no longer a problem, owing to the inventive process. Indeed, the recovered liquid can be completely or partially reintroduced into the containers by topping up.

Thus, the process according to the invention allows:
a new product made up of the liquid 56, 72 sold as recovered, or transformed, or aged in drums,
very significant gains for spirits producers,
leveraging of inventories,
higher-quality products with a high value,
a possibility of aging the spirits in the drum for a longer time, without increasing volume losses related to the angels' share,
a greater mastery of the maturation of the alcoholic liquids by the cellar master,
greater diversity of the produced alcoholic beverages, owing to the new possibilities for control and traceability of the maturation of the alcoholic liquids, as well as assembly (assembly of vintages of spirits and “angels' shares”), and/or
an accentuation of certain flavors and aromas in the products for which the “angels' share” is added to the assembly, giving the impression of a new taste and smell.

1. A process for maturing at least one alcoholic liquid, the alcoholic liquid being intended to become an alcoholic beverage or an alcoholic beverage ingredient, the process including at least the following steps:
using a chamber located in a wine cellar, and containing at least one container that contains the alcoholic liquid, the container being at least partly made from wood or containing wood, and an internal atmosphere including oxygen, the chamber being airtight or semi-airtight,
optionally making the chamber airtight,
maturing the alcoholic liquid in the container, the maturation consuming some of the oxygen present in the internal atmosphere and releasing volatile compounds coming from the alcoholic liquid into the internal atmosphere,
extracting a portion of the internal atmosphere from the chamber in order to obtain a gaseous mixture to be treated comprising at least a portion of the volatile compounds,
separating the gaseous mixture to be treated into at least a residual gaseous mixture depleted in said volatile compounds relative to the gaseous mixture to be treated, and at least one recovered liquid containing at least some of the volatile compounds of the gaseous mixture to be treated,
evacuating at least a portion of the residual gaseous mixture to the outside of the chamber, and
allowing air into the chamber by forced convection,
the recovered liquid being intended to form an alcoholic beverage or an ingredient of a composition.

2. The process according to claim 1, wherein the chamber is formed by the wine cellar itself, a portion of the wine cellar, or a container located in the wine cellar.

3. The process according to claim 1, wherein:
the extraction is done by an extractor located outside the wine cellar, or
the separation of the gaseous mixture to be treated is done outside the wine cellar, or
the evacuation is done outside the wine cellar.

4. The process according to claim 1, further including a step for storing the recovered liquid in at least one receptacle.

5. The process according to claim 1, further including a step for measuring the oxygen level or the level of one or several of the volatile compounds in the internal atmosphere of the chamber.

6. The process according to claim 1, wherein the chamber contains several containers that respectively contain alcoholic liquids, the alcoholic liquids being identical according to one or several of the following criteria: varietal, soil, level of maturity and aging process.

7. The process according to claim 1, wherein the extracting step of a portion of the internal atmosphere is done in a first location of the chamber, and the air intake is done in a second location of the chamber, the first location and the second location being opposite one another in the chamber so as to create gas sweeping around the container.

8. The process according to claim 1, wherein the separating step is done at least by one or several of the following modules:
a PSA, VSA or TSA separating module containing at least one adsorbent bed, the adsorbent being suitable for selectively adsorbing the air from the gaseous mixture to be treated relative to the at least one portion of the volatile components present in the gaseous mixture to be treated, or at least one portion of the volatile compounds relative to the air,
a membrane separating module,
a condenser suitable for condensing at least a portion of the volatile compounds present in the gaseous mixture to be treated, and
a distiller suitable for distilling a mixture including at least a portion of the volatile compounds present in the gaseous mixture to be treated.

9. The process according to claim 1, wherein the separating step is split so as to obtain the recovered liquid and one or several other recovered liquids, each of the other recovered liquids including a portion of the volatile compounds present in the gaseous mixture to be treated.

10. An installation for maturing at least one alcoholic liquid intended to become an alcoholic beverage or an alcoholic beverage ingredient, the installation including:
at least one chamber intended to be located in a wine cellar, the chamber being airtight or semi-airtight and including an internal atmosphere including oxygen, the chamber optionally being made airtight,
at least one container intended to be located in the chamber and to contain the alcoholic liquid, the container being at least partially made from wood or containing wood, and the container being suitable for allowing maturing of the alcoholic liquid, the maturation consuming some of the oxygen present in the internal atmosphere and releasing volatile compounds coming from the alcoholic liquid into the internal atmosphere,
at least one extractor for extracting a portion of the internal atmosphere ) from the chamber and obtaining a gaseous mixture to be treated comprising at least a portion of the volatile compounds,
at least one separator for separating the gaseous mixture to be treated into at least a residual gaseous mixture depleted in said volatile compounds, and at least one recovered liquid containing at least some of the volatile compounds of the gaseous mixture to be treated,
at least one evacuation system for evacuating at least 50 vol %, of the residual gaseous mixture to the outside of the chamber, and
at least one air intake system for allowing air into the chamber by forced convection,
the recovered liquid being intended to form an alcoholic beverage or an ingredient of a composition.

11. The process according to claim 1, wherein all of the residual gaseous mixture is evacuated to the outside of the chamber.

12. The process according to claim 1, wherein the composition is an alcoholic beverage or a perfume.

13. The process according to claim 4, wherein the at least one receptacle has at least one unidirectional inlet to receive the recovered liquid.

14. The process according to claim 5, further including a step for regulating one or several of these levels, the regulating step including a modification of the step for extracting a portion of the internal atmosphere of the chamber, or a modification of the air intake step.

15. The installation according to claim 10, wherein the evacuation system is adapted for evacuating all of the residual gaseous mixture to the outside of the chamber.

16. The installation according to claim 10, wherein the composition is an alcoholic beverage or a perfume.
